(19) United States
(12) Patent Application Publication
(10) Pub. No.: US 2015/0055781 A1
(43) Pub. Date: Feb. 26, 2015

(54) WIRELESS SPEAKER DEVICE AND WIRELESSLY MULTI-CHANNEL AUDIO SYSTEM THEREOF

(71) Applicant: Yu-Wen CHEN, Taipei (TW)

(72) Inventor: Yu-Wen CHEN, Taipei (TW)

(73) Assignee: Global Digitech Co., LTD., Taipei (TW)

(21) Appl. No.: 14/302,344

(22) Filed: Jun. 11, 2014

(30) Foreign Application Priority Data
Aug. 20, 2013 (TW) 102215592

(51) Int. Cl. H04R 5/04

(52) U.S. Cl. CPC H04R 5/04; H04R 2420/07
USPC 381/2

(57) ABSTRACT

A wireless speaker device includes a speaker module, a processing module, a wireless module and a control module. The processing module may receive the mate signal sent by the adjacent wireless speaker device through the wireless module or send the mate signal sent to the adjacent wireless speaker device through the wireless module to establish a wireless multi-channel audio system. Therefore, the connections of the wireless speaker devices within the wireless multi-channel audio system are simplified. Ans the cost time to mate for connection is reduced. Also, the connection is automated to be convenient for users to operate.

### BACKGROUND OF THE INVENTION

1. Field of Invention

The present invention relates to a speaker device, in particular to a wireless speaker device adapted to wirelessly mate with each other to establish the multi-channel audio system.

2. Related Art

Current audio systems generally require their speakers to be hard-wired back to the main system components. Thus, the complexity of these systems is increasing. For example, surround sound systems use six speakers, some of which may be located at a considerable distance from the main system. Because wires must be run to each speaker throughout a room and potentially throughout a house, the distraction or nuisance of the wires increases the complexity of the systems.

The drawbacks of hard-wired systems have been addressed in part by wireless headphones or speakers. Wireless headphones or speakers that receive musical signals transmitted directly from home stereo systems or portable music players are known. These audio systems include the wireless speaker systems exclusively used in their main system components. These wireless speaker systems cannot be used in conjunction with other existing wireless speaker systems. There is no way to combine the existing wireless speaker systems with the new wireless speaker systems. Thus, customers purchase an entirely new home entertainment system to obtain the wireless speaker system.

It is desirable to provide a wireless speaker system by which the users can combine a plurality of wireless speakers to establish a wireless surround sound system, or combine the existing wireless speaker systems with the new wireless speaker systems without the troublesome inconvenience of mating the wireless speakers.

### SUMMARY OF THE INVENTION

This invention discloses a wireless speaker device. The wireless speaker device of this invention includes a speaker module, a processing module, a wireless module and a control module. The processing module is controlled to switch in a master mode and to mate with the adjacent wireless speaker device to establish a wireless multi-channel audio system with multiple wireless speaker devices. Therefore, the connections of the wireless speaker devices within the wireless multi-channel audio system are simplified.

Furthermore, the wireless speaker device is controlled to switch in a slave mode and to receive a mate signal sent by adjacent wireless speaker device to connect. Therefore, the cost time to mate for connection is reduced. Also, the connection is automated to be convenient for users to operate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 illustrates the block diagram of the first embodiment according to the wireless speaker device of this invention.

FIG. 2A illustrates the respective view of the first embodiment according to the wireless multi-channel audio system of this invention.

FIG. 2B illustrates the sequence diagram for mating of the first embodiment according to the wireless multi-channel audio system of this invention.

FIG. 3 illustrates the respective view of the second embodiment according to the wireless multi-channel audio system of this invention.

FIG. 4 illustrates the block diagram of the second embodiment according to the wireless speaker device of this invention.

FIG. 5 illustrates the block diagram of the control module according to the speaker device of this invention.

### DETAILED DESCRIPTION OF THE INVENTION

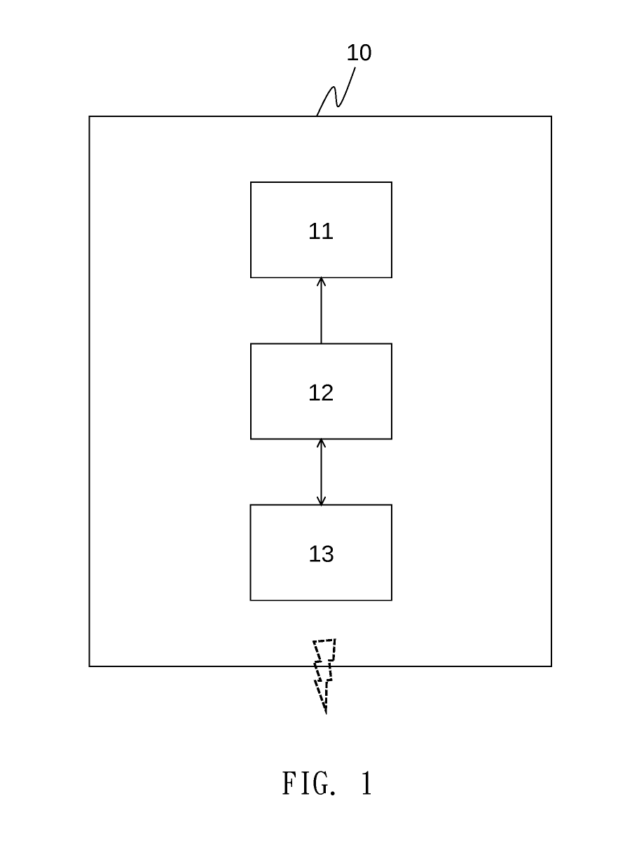

FIG. 1 illustrates the block diagram of the first embodiment according to the wireless speaker device of this invention. The wireless speaker device 10 of this invention includes a speaker module 11, a processing module 12 and a wireless module 13. The speaker module 11 is connected to the processing module 12 and adapted for playing the received audio signal from the information processing device. The wireless module 13 is also connected to the processing module 12 and is adapted for transmitting and receiving a mate signal and an audio signal. The processing module 12 is controlled to switch in a master mode or in a slave mode and to mate with the adjacent wireless speaker device. The wireless module 13 is connected to the adjacent wireless speaker device and the information processing device by the transmission method such as the wireless audio transmission, the wireless radio frequency(RF) transmission and the Near Field Communication(NFC).

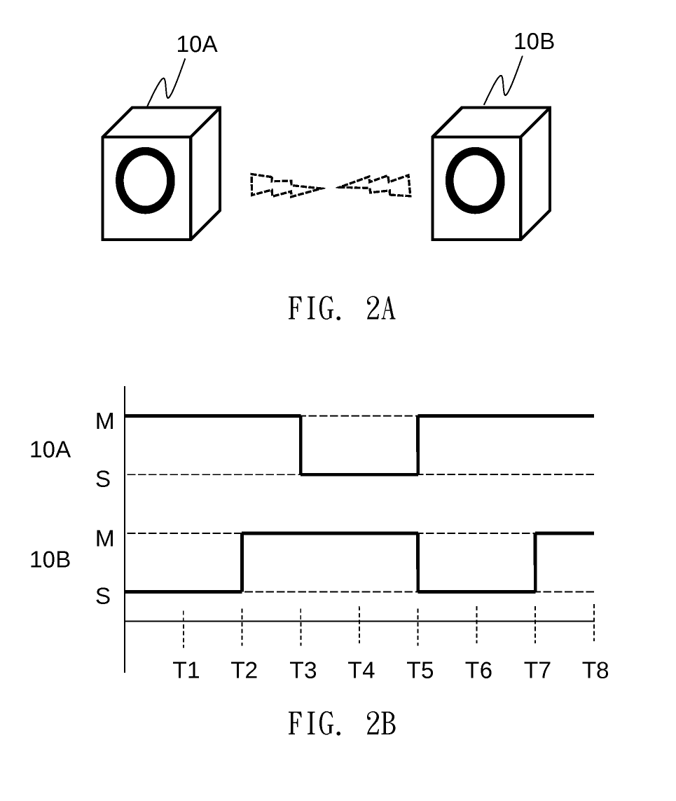

FIG. 2A illustrates the respective view of the first embodiment according to the wireless multi-channel audio system of this invention. When the wireless speaker devices 10A, 10B are activated to mate to each other, the wireless speaker devices 10A, 10B are communicated to determine one of the the wireless speaker devices 10A, 10B is the master one and another one is slave one. Please see FIG. 2B, each of the wireless speaker devices 10A, 10B has the default mating time sequence profile to switch in the master mode or in the slave mode accordingly.

During times T1 to T3, the wireless speaker device 10A is in the master mode. The wireless speaker device 10A will send the mate signal for match. During times T1 to T2, the wireless speaker device 10B is in the slave mode. When the wireless speaker device 10B receives the mate signal from the wireless speaker device 10A, the wireless speaker devices 10A, 10B are connected to establish a dual-channel wireless audio system without setup or control by the users. The wireless speaker device 10A is in the master mode and the wireless speaker device 10B is in the slave mode to process and player the audio signals belong to its channel respectively.

If the wireless speaker devices 10A, 10B does not connect before time T2, the wireless speaker device 10B is switched in the master mode. Due to both wireless speaker devices 10A, 10B are in the master mode, the wireless speaker devices 10A, 10B cannot be mated to connect. During times T3 to T5, the wireless speaker device 10A is in the slave mode. The wireless speaker device 10A may receive the mate signal from the wireless speaker device 10B to be connected.

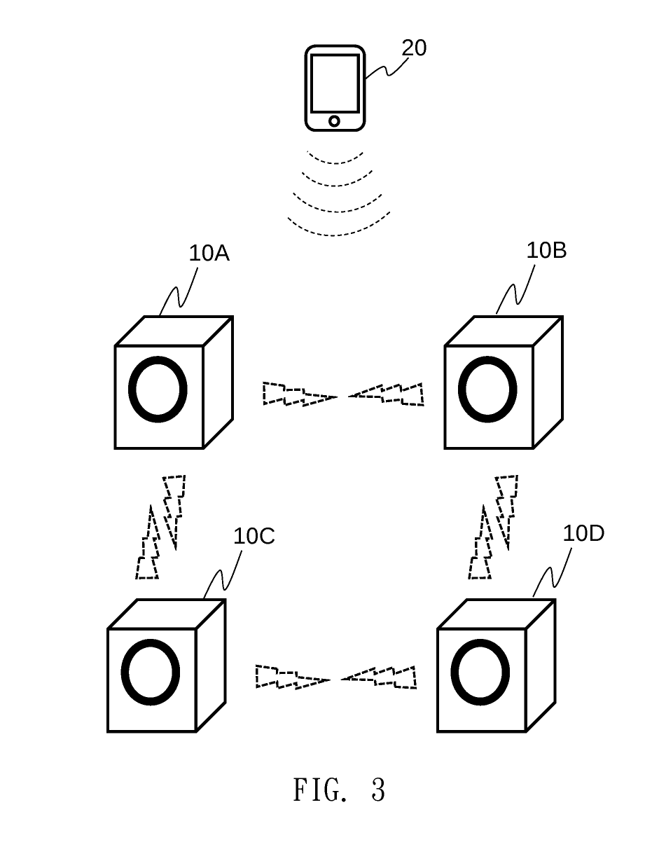

FIG. 3 illustrates the respective view of the second embodiment according to the wireless multi-channel audio system of this invention.

The wireless multi-channel audio system includes four wireless speaker devices 10A, 10B, 10C and 10D. When the wireless speaker devices 10A-10D are activated to mate to each other, the wireless speaker devices 10A-10D are communicated to determine one of the the wireless speaker devices 10A-10D is the master one and the others are slave ones.

Each of the wireless speaker devices 10A-10D has the default mating time sequence profile to switch in the master mode or in the slave mode accordingly. Each wireless speaker devices 10A-10D is switched in the master mode and in the slave mode until being mated to establish the wireless multi-channel audio system. Only one of the wireless speaker devices 10A-10D is able to wireless connect to the information processing device 20. The audio data may wirelessly transmit to the wireless speaker devices 10A-10D to play in the whole wireless multi-channel audio system, i.e. the wireless speaker devices 10A-10D.

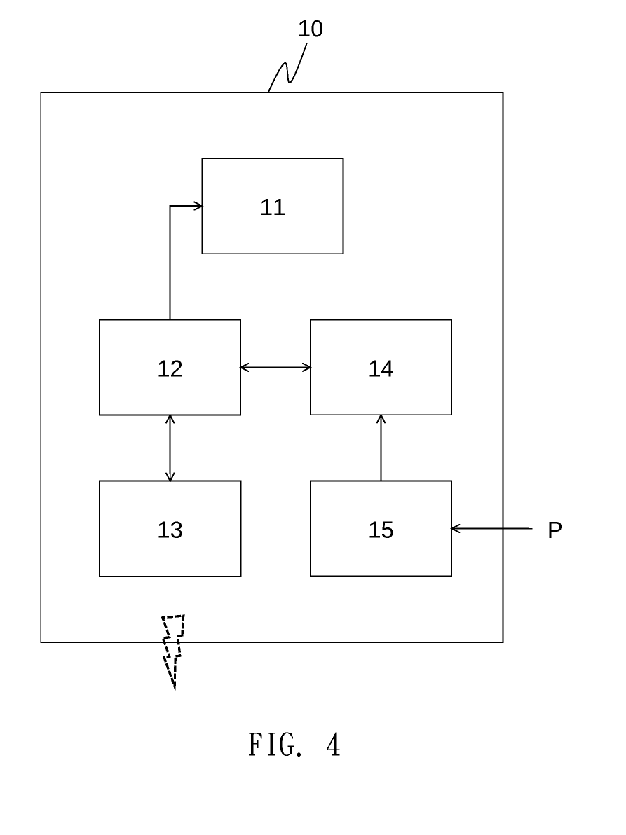

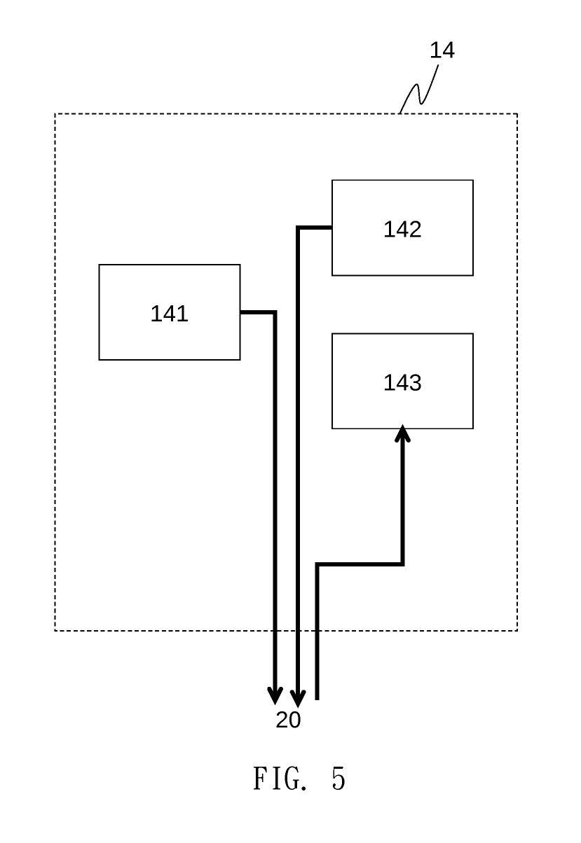

FIG. 4 illustrates the block diagram of the second embodiment according to the wireless speaker device of this invention. The wireless speaker device 10 of this invention may further include a control module 14 and a power supply module 15. The power supply module 15 includes a storage adapted to store a working power, and has a power terminal to receive the working power P. As refer to FIG. 5, the control module 15 is used to control the status of the wireless speaker device 10 and includes a volume control unit 141, a play control unit, a power control unit 142 and a display unit 143. The volume control unit 141 is used to control the sound volume of the wireless speaker device 10. The power control unit 142 is used to turn-on or turn-off the wireless speaker device 10. The display unit 143 is adapted to display a status of the wireless speaker device 10, such as channel information.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless speaker device, wirelessly connecting to an adjacent wireless speaker device to establish a multi-channel audio system, the wireless speaker device comprising:
a wireless module, adapted for transmitting and receiving a mate signal and an audio signal; and
a processing module, connected to the wireless module and adapted to receive the mate signal in a slave mode to process sequence and to mate with the adjacent wireless speaker device; and
a speaker module, connected to the processing module and adapted for playing the audio signal after being mated.

2. The wireless speaker device of claim 1, wherein the processing module is in a master mode when the mate is not complete to transmit the mate signal to the adjacent wireless speaker device.

3. The wireless speaker device of claim 1, wherein the wireless module is mated with the adjacent wireless speaker device by the transmission method selected from the group consisting of the wireless audio transmission, the wireless radio frequency(RF) transmission and the Near Field Communication(NFC).

4. The wireless speaker device of claim 1, further comprises a control module connected to the processing module.

5. The wireless speaker device of claim 1, wherein the processing module is switched in master mode and in slave mode according to a default mating time sequence profile.

6. The wireless speaker device of claim 1, further comprises a power supply module adapted to store a working power, and has a power terminal to receive the working power.

7. A wireless multi-channel audio system, including a plurality of wireless speaker devices, wherein the wireless speaker device is mated with to an adjacent wireless speaker device wirelessly.

8. The wireless multi-channel audio system of claim 7, wherein the wireless speaker device comprising:
a wireless module, adapted for transmitting and receiving a mate signal and an audio signal; and
a processing module, connected to the wireless module and adapted to receive the mate signal in a slave mode to process sequence and to mate with the adjacent wireless speaker device; and
a speaker module, connected to the processing module and adapted for playing the audio signal after being mated.

9. The wireless multi-channel audio system of claim 8, wherein the processing module is in a master mode when the mate is not complete to transmit the mate signal to the adjacent wireless speaker device.

10. The wireless multi-channel audio system of claim 8, wherein the wireless module is mated with the adjacent wireless speaker device by the transmission method selected from the group consisting of the wireless audio transmission, the wireless radio frequency(RF) transmission and the Near Field Communication(NFC).

11. The wireless speaker device of claim 8, wherein the processing module is switched in master mode and in slave mode according to a default mating time sequence profile.
